(19) United States
(12) Patent Application Publication
(10) Pub. No.: US 2025/0032830 A1
(43) Pub. Date: Jan. 30, 2025

(54) SELF-CLOSING VENT ASSEMBLY FOR A BUILDING

(71) Applicant: Vulcan Technologies, Inc., Novato, CA (US)

(72) Inventor: Ronald J. Loar, Berkeley, CA (US)

(21) Appl. No.: 18/382,445

(22) Filed: Oct. 20, 2023

Related U.S. Application Data
(60) Provisional application No. 63/418,382, filed on Oct. 21, 2022.

(51) Int. Cl. A62C 2/06; F24F 11/35

(52) U.S. Cl. CPC A62C 2/065; F24F 11/35; F24F 2221/52

(57) ABSTRACT

A self-closing vent has its frame and honeycomb screen coated with an intumescent material. When affixed to an external wall or eave of a building, the vent is normally open, allowing free flow of air into and out of the building, but when exposed to the heat of a fire, such as a wildfire, the intumescent material expands to close the vent, thereby preventing an external fire from entering the building. Enhancements include a weather-protective topcoat over the intumescent material, a fine mesh screen over the interior side of the honeycomb screen, and a protective set of louvers at the outside of the vent.

This application claims benefit of application Ser. No. 63/418,382 filed Oct. 21, 2022.

### BACKGROUND OF THE INVENTION

This invention relates to a fire-rated, self-closing vent for soffits and walls connecting the exterior of a building to its interior. The vent comprises a screen surrounded by a peripheral frame, the vent structure having no moving parts. The screen is formed of cells, preferably a honeycomb, coated with an intumescent material. Under normal conditions the cells are open to freely pass air and serve to ventilate crawl spaces, attics, etc., or allow air flow between rooms. When subjected to the elevated temperatures of an external fire (or internal fire), the intumescent material expands to close the cells, thus preventing flames, heat, and gaseous fumes from entering the building.

Prior U.S. Pat. Nos. 7,191,845 and 7,413,024 are related to the subject matter of this invention and are incorporated herein by reference in their entirety. See also U.S. Pat. No. 2,279,971.

A major problem in many areas, particularly dry areas, is the occurrence of wildfires, mainly brush fires and forest fires, and the concomitant damage they do to property in their paths. Houses, offices, and other buildings are constructed and maintained so as to prevent the spread of internal fires from one room to another. Included in this effort is the use of an intumescent coated screen or grill as a self-closing vent in interior walls, floors, ceilings, or ventilation ducts, all of which provide open air-flow between rooms under normal conditions but which close when exposed to high temperatures.

See also U.S. Pat. Nos. 3,976,825, 4,093,818, 5,957,211, 6,256,948, and U.K. patent documents Nos. 1500913 and 2107183. The U.S. '818 patent cited above shows a cellular, honeycomb-type structure which is extremely elongated and is positioned in a duct way for surface lines, such as cables. The cables are fed directly through individual tubes defined by the elongated honeycomb structure, with the purpose being to close off air flow to these tubes in the high heat situation of a fire.

The two British patent documents both show hexagonally-shaped honeycomb-like cellular meshes coated with intumescent material for automatic closure under fire conditions. The metal mesh is designed to be used in ventilation openings or ducts.

The current invention is in part an improvement over the constructions shown in U.S. Pat. Nos. 7,413,024 and 7,191,845 referenced above.

Prior vents with intumescent coatings have not been constructed in the advantageous manner of the present invention described below.

### SUMMARY OF THE INVENTION

The present invention overcomes the difficulties described above by providing a self-closing vent designed to replace existing vents which connect interior spaces of a building, or connect the exterior of a building with its interior. Further, the invention improves the construction of a self-closing vent with intumescent coating, in effectiveness of the closing feature and in efficiency of production, installation and operation.

The present invention accomplishes the above by providing a self-closing vent coated with an intumescent coating, said self-closing vent either as original equipment or as a replacement for existing vents. Improvements include a fine mesh directly adjacent to a honeycomb screen bearing the intumescent coating, and an exterior protective top coat over the intumescent coating to prolong weather resistance and overall longevity.

It is an object of the invention to provide a self-closing vent of efficient, improved construction which prevents fire from spreading through vents which connect spaces in a building or connect interior and exterior spaces. These and other objects and features of the invention will be apparent from the following description of a preferred embodiment, considered along with the accompanying drawings.

### DESCRIPTION OF THE DRAWINGS

FIG. 1 is a side cross-sectional view of a building which illustrates the present invention.

FIG. 2 is a back view of one preferred embodiment of the present invention.

FIG. 3 is a side cross-sectional view of the disclosed embodiment as seen along lines 3-3 of FIG. 2.

FIG. 4 is a cross section view showing another embodiment of the invention.

FIG. 5 is an exterior elevation view showing the assembly of FIG. 4.

### DESCRIPTION OF PREFERRED EMBODIMENTS

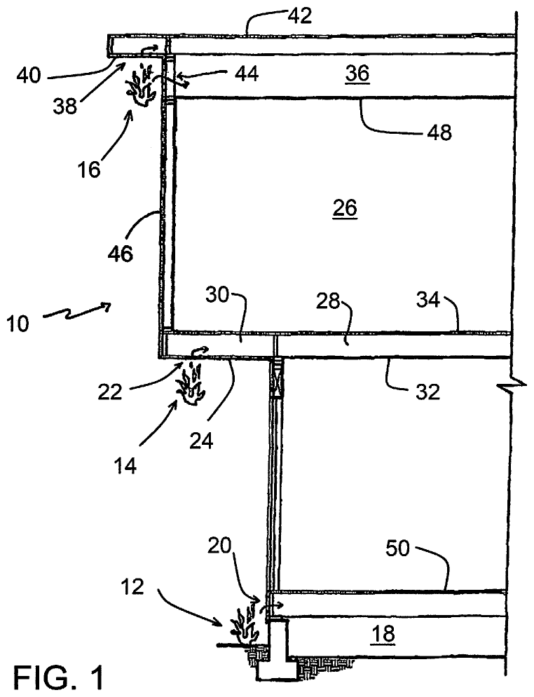

Referring to FIG. 1, a diagrammatic side view in cross-section of a building 10 shows how an external fire, represented by flames 12, 14, and 16, can gain entrance into a building. A crawl space 18 includes vents 20 which allow circulation of air therethrough to prevent trapping of stale air and moisture therewithin. Soffit vents 22 through an eave 24 beneath the overhang of an upper story 26 provide required venting, particularly of moisture, of joist cavities 28 formed between structural joists 30, ceiling 32, and floor 34. The accumulation of hot air in attic 36 is relieved either by soffit vents 38 in the eaves 40 of the roof 42 and/or through attic vents 44 which penetrate through external walls 46 above ceiling 48. The foregoing describes common practices in the building industry.

Vents opening externally of the building are usually designed to freely promote circulation, and no thought has been given to closing them. Soffit vents 22 and 38 are often just holes formed in external siding, since being beneath the eaves 24 and 40 of an overhanging second story 26 and roof 42, respectively, they are not directly exposed to the weather. Attic vents 44 usually comprise either an open-mesh screen covering an opening into the attic 36 or a plurality of fixed, overlapping louvers, if it is anticipated that the vent will be exposed to wind-blown rain or snow. All of these vents are permanently open. Crawl space vents 20 are the exception, especially in colder climates where it is desirable to have them closed during the winter months to prevent the loss of heat through the floor 50. The vents 20 usually comprise vanes journalled in perimetrical frames, the vanes being rotatable from horizontally spaced to vertically overlapping. Some vents 20 comprise a pair of apertured plates, one of which is fixed while the other slides relative thereto to align or to close the apertures. Both are opened and closed mechanically, usually by hand by direct action of a human being. In the event of fires, external or internal, no one takes the time to close the vents 20, and, of course, the soffit vents 28 and 30 and the attic vents 42 cannot be closed.

Exterior vents provide unintended entries of external fires and should be automatically closed when exposed to an approaching wildfire. (Hot gasses produced by internal fires also should not be allowed to exit through the vents, for this draws fresh air into the building which feeds the fire, but that is not the primary object of this invention.) The invention is therefore directed toward vents which are designed to allow free passage of airflow through external walls under normal circumstances but to close when subjected to high temperatures as would be experienced from an external wildfire.

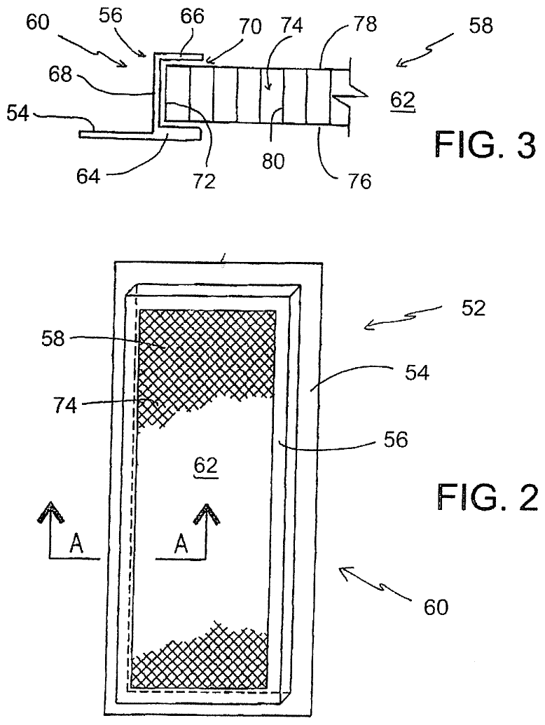

Turning to FIG. 2 a perspective back view of a preferred self-closing vent 52 is shown. The vent 52 comprises two parts, a combination peripheral flange 54 and integral U-shaped body 56, and a honeycomb screen 58. The flange 54 and U-shaped body 56 combine to form a one-piece frame 60 surrounding a central opening 62. The frame 60 is shown in the shape of a rectangle, but this is for illustrative purposes only. It could be any convenient geometric or decorative figure, e.g., a square, oval, hexagon, octagon, circle, star, etc. The flange 54 is preferably made of 22 gauge (or a range of 30 to 20 gauge) galvanized sheet metal and is substantially flat (FIG. 3). The U-shaped body 56 is offset relative to the plane of the flange 54. That is, as seen in FIG. 3, wherein one segment of frame 60 is shown in cross-section in the direction of arrows 3-3 of FIG. 2, the body 56 comprises a first leg 64, a second leg 66, and a web 68 connecting legs 64 and 66. The hollow interior 70 of the U-shaped body 56 opens away from the web 68 toward the central opening 62.

In one preferred embodiment, the peripheral edge 72 of the screen 58 is rigidly secured within the hollow interior 70 of the body 56 by any convenient means, such as by welding, brazing, or by an epoxy adhesive. In this preferred embodiment, there is no relative movement of the screen 58 and frame 60, so the self-closing vent 52 can be literally characterized as a rigid, integral structure with no moving parts.

Other embodiments will also fall within the scope of the disclosed invention. For instance, the frame 60 could be constructed without the leg 66 and with the screen 58 secured either to the leg 64 or web 68, or both. So long as the flange 54 of the frame 60 can be fastened to the external surface of the wall 46 and holds the screen 58 such that it covers the vent opening (not shown) in the wall, the desired results of the invention will be effected.

In the simplest construction, the screen 50 is cut to shape, and the frame 60 is assembled around it. In this most preferred embodiment, the screen 58 is not integral with the frame 60, but rather the peripheral edge 72 fits loosely within the hollow interior 70 of the body 56 and is completely contained therein. Even though slight movement is possible between the screen 58 and the frame 60, the vent 52 is considered for patent purposes as having no moving parts, inasmuch as any relative movement is inconsequential, producing neither a useful function nor any ill effects. The peripheral edge 72 follows the contours of the frame 60 very close to the web 68, so it will be appreciated that the screen 58 entirely covers the central opening 62 (FIG. 2).

The screen 58 preferably comprises a honeycomb structure having hexagonal cells 74 which are open through the screen 58 from the front 76 to the back 78. The screen 58 may be about ⅝ inch thick and is preferably comprised of walls 80 formed of 3 mil stock aluminum. The cells 74 are preferably substantially ¼ inch wide, although this can vary. The U-shaped body 56 completely encloses any sharp edges that the peripheral edge 72 may have suffered during construction of the screen 58. With the frame 60 having a reasonably smooth exterior itself, the vent 52 is without sharp edges, a feature which facilitates its safe handling, storage, and transporting.

The vent 52 is coated in its entirety with an intumescent material. The coating is preferably about 10 mils thick, so it is apparent that virtually the entire width of each cell 74 is open under ambient conditions for free flow of air. When exposed to high temperatures, such as those associated with a fire, however, the intumescent material expands and carbonizes to form a solid barrier which is impenetrable by heat or by gasses.

The shape and dimensions of the vent 52 will vary depending upon the intended location of use. A typical set of dimensions for the vent 52 is as follows: (1) The outside dimensions of the flange 54 may be approximately 7.25 inches by 15.25 inches. (2) The outside dimensions of the U-shaped body 56 may be approximately 5.75 inches by 11.75 inches. (3) The thickness of the screen 58 is approximately 0.63 inch. (4) The width of the web 68 is approximately 0.69 inches. And, (5) the width of the legs 64 and 66 of the U-shaped body 56 may be approximately 0.50 inches.

In use, for new building constructions, a vent opening is formed wherever appropriate in the external walls (the term “external wall” as used herein and in the claims incorporates any externally exposed structure, including first or second story wall 46, eaves 24 and 40, and the wall surrounding crawl space 18), and the body 56 of the self-closing vent 52 is fit therein. The flange 54 of the frame 60 is attached to the outside surface of the wall 46 around the vent opening. To retrofit the self-closing vent 52 to an existing building, the building's external vents are removed, and each is replaced with a self-closing vent 52 mounted on the exterior wall or eave as before. The flange 54 is pressed flat upon the wall 46 with the U-shaped body 56 extending inwardly therefrom into a vent opening through the exterior wall or eave. The vent 52 is either shaped to fit an existing aperture, or a new aperture is formed having a dimension such that a standard body 56 fits snugly therewithin. The flange 54 is then fixed to the exterior wall 58 by suitable fasteners, e.g., screws, nails, etc. As is apparent from FIG. 3, the flange 54 is coplanar with the leg 64, so both present a smooth external surface, when the flange 54 is attached flush onto an external wall. Any gaps which might exist between the external wall and vent 52 can be sealed with caulking or weatherstripping if deemed appropriate. Air will naturally flow freely through the cells 74 until the intumescent material is expanded by excessive heat at which time all of the cells 74 as well as any gaps remaining between the vent 52 and the exterior wall or eave of the building will be sealed by the expanded intumescent material, blocking all air flow and thereby preventing access therethrough of any flames.

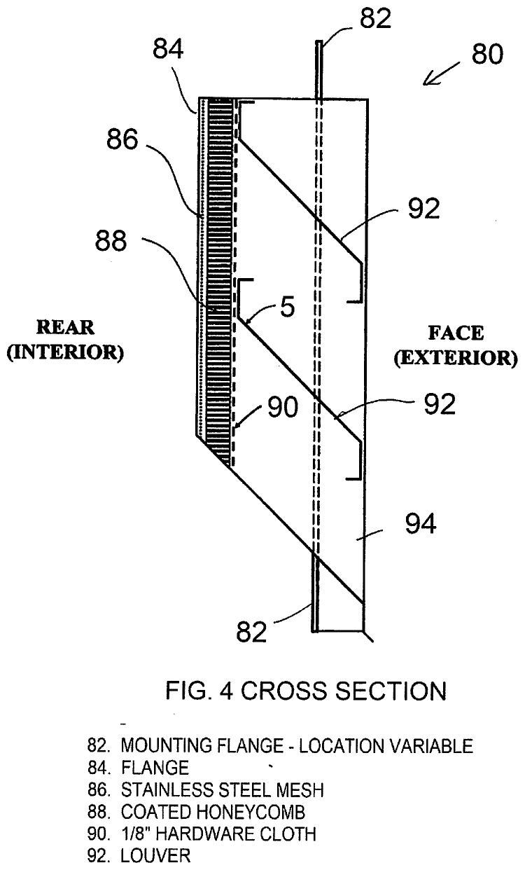

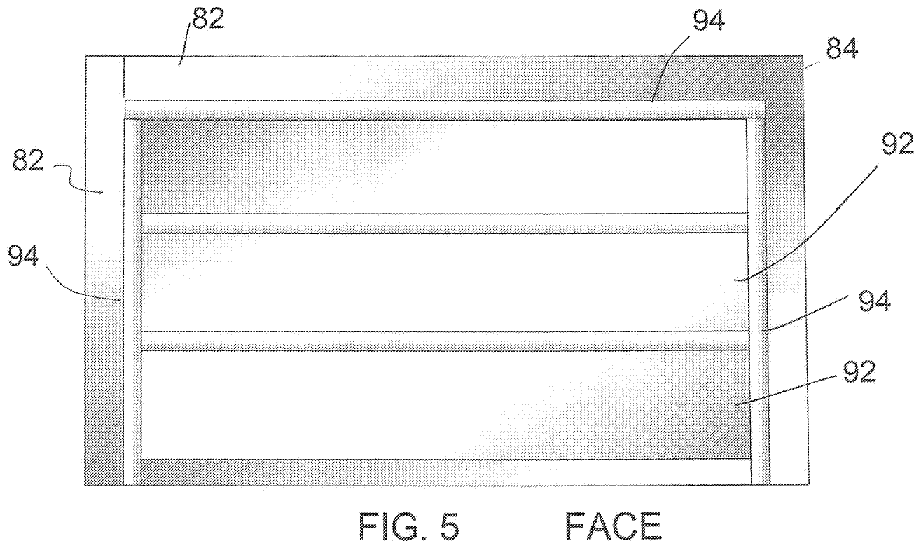

A further embodiment of the invention is shown in FIGS. 4 and 5. The illustrated installation is at the exterior wall of a building, although it could be used in a wall between rooms if desired.

FIG. 4 shows the vent installation 80, with a mounting flange 82 for securing the installation to a wall, typically the exterior wall or overhang or soffit of a building. At the rear of the assembly an internal flange 84 is shown, securing the unit together generally as in the above embodiment. The flange forms a frame around the active components of the assembly. At 86 is shown a fine, stainless steel mesh which is open and only engaged by the flange at its periphery, retaining the mesh in place. Just adjacent to the mesh 86 is a coated honeycomb structure 88, similar to that described above but with some further improved features. Toward the exterior and adjacent to the honeycomb structure 88 is a layer of hardware cloth 90, which can be about ¼ inch in opening size, or a range of about 3/32 inch to ¼ inch. Such hardware cloth, typically of woven synthetic material, has been used previously in fire-prevention vents but in a large opening size. Its purpose is primarily to keep dirt and debris from entering the honeycomb structure. The coating is an intumescent material, such as a proprietary intumescent coating from FireFree Coatings Inc., the assignee of this invention.

This embodiment also includes a set of louvers 92, these parallel louvers being shown in FIG. 4 and in the exterior view of FIG. 5. The louvers are permanently open, and provide increased durability against snow loads or other damaging forces at the exterior of the building, particularly when the installation is in a vertical wall of the building. Frame pieces supporting the louvers are shown at 94. These can extend out from the flange 82.

The embodiment of FIGS. 4 and 5 improves over the earlier embodiments in several ways. The honeycomb structure preferably has small openings, about 5 mm (0.2 inch) or less at the smaller dimension of the preferably hexagonal openings (or no greater than about ¼ inch). The fine mesh 86, preferably a stainless steel mesh, preferably has openings in a range of about 0.01 to 0.09 inch (or more preferably a range of about 0.008 inch to about 0.02 inch), smaller than in previous such screens. Its purpose, laid directly adjacent to the interior or rear surface of the intumescent-coated honeycomb 88, is to aid in the adhesion of the intumescent materials and to screen out fine dirt or grit, as well as to contain the intumescent material within the substrate structure.

The depth of the honeycomb structure 88, i.e. its thickness, can be about ¼ inch to ¾ inch, or as desired. With the smaller honeycomb openings of this embodiment, and the resulting greater surface area for intumescent coating, the thickness of the structure 88 can be less than in previous vents.

A further addition in this embodiment of the invention is the application of a protective topcoat over the intumescent coating, which may be a sprayed-on acrylic coating compatible with the intumescent material. This is applied thinly to all surfaces of the intumescent-coated honeycomb structure 88, to protect from weather and promote overall longevity of the intumescent substrate.

The term “about” as used herein and in the claims is to be understood as within 10% of the value stated.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

I claim:

1. A self-closing venting system for preventing an external fire from entering a building through external vents, comprising:
an external wall of a building, said external wall including a wall vent opening therethrough,
a self-closing vent positioned in the wall vent opening, comprising a frame defining a central opening, a screen within the frame and covering the central opening while allowing free flow of air therethrough, the walls of the screen being coated with a layer of an intumescent material which closes the screen when subjected to heat produced by an external fire,
the self-closing vent further including a plurality of parallel louvers each extending at an oblique angle to the screen within the central opening, positioned toward exterior of the building from the screen, and a protective top coat over the intumescent coating.

2. The self-closing vent system of claim 1, wherein the protective top coat over the intumescent coating comprises a sprayed-on acrylic coating.

3. The self-closing vent system of claim 1, further including a protective screen adjacent to and interior of the screen, having openings in a range of about 0.008 inch to 0.02 inch.

4. The self-closing vent system of claim 2, wherein the protective screen is a woven stainless steel screen.

5. The self-closing vent system of claim 2, wherein the protective screen has openings of about 0.014 inch.

6. The self-closing vent system of claim 1, further including a layer of hardware cloth on the exterior side of the screen.

7. The self-closing vent system of claim 6, wherein the hardware cloth comprises woven synthetic material.

8. The self-closing vent system of claim 6, wherein the hardware cloth has openings of about ⅛ inch.

9. The self-closing vent system of claim 1, wherein the screen comprises a honeycomb structure with a depth in the range of about ¼ inch to ¾ inch.

10. The self-closing vent system of claim 1, wherein the wall is vertical and the parallel louvers are angled downwardly toward the exterior of the wall.
